(19) United States
(12) Patent Application Publication
(10) Pub. No.: US 2005/0071688 A1
(43) Pub. Date: Mar. 31, 2005

(54) Hardware CPU utilization meter for a microprocessor

(75) Inventors: David F. Hepner, San Jose, CA (US); Andrew D. Walls, San Jose, CA (US)

Correspondence Address: RICHARD M. GOLDMAN, 371 ELAN VILLAGE LANE, SUITE 208, CA, 95134, US

(73) Assignee: International Business Machines Corporation

(21) Appl. No.: 10/671,251

(22) Filed: Sep. 25, 2003

(51) Int. Cl. G06F 1/26

(52) U.S. Cl. 713/300

(57) ABSTRACT

A hardware based solution to CPU utilization and power management that avoids an additional set of software tasks to monitor CPU utilization. The system has a CPU, a counter; a monitor, and a clock. The clock provides a CLK signal to the counter when a software task is running on the CPU, and the counter counts the number of clock pulses since a RESET. The monitor samples and holds the value of the counter at the last RESET. The counter outputs a signal to the monitor that is responsive to the count content at the time of the last reset. The monitor outputs this value as a control signal. This control signal may be a power control signal, a function control signal, or even a clock control signal, responsive to count content. For example, the counter may output a control signal reducing power input or clock pulse input to the CPU responsive to monitor value when the CPU utilization is below a threshold.

### FIELD OF THE INVENTION

The invention described herein relates to central processing unit utilization meters and especially to utilization meters used for CPU power management.

### BACKGROUND OF THE INVENTION

Embedded processors are ubiquitous. They are frequently paused, waiting for a request to perform a task. However, even when waiting to perform a task, they are consuming power, frequently limited battery power, and emitting heat. In many mobile environments, for example in aircraft, automobiles, and portable consumer electronics, by way of example, merely consuming energy while waiting for a task is undesirable, as it discharges batteries or requires larger generators or alternators. Even a notebook format personal computer wastes heat and battery power waiting for such mundane tasks as the user typing a single character.

Similarly, embedded microprocessors pack a lot of functionality into a 25 watt PCI form factor, frequently in a drawer with many other cards. The power drain of an unused microprocessor is siphoned from utilized microprocessors and thereafter wasted as heat.

Thus, from both a power management perspective and a thermal management or heat dissipation perspective, it would be desirable to be able to throttle back microprocessors not currently in use, for example to reduce the clock speed of the CPU and other logic when the CPU is idle. Moreover, it would be beneficial to accomplish this in hardware, without adding to the software load of the processor.

### SUMMARY OF THE INVENTION

The method and system of our invention provides a hardware based solution to CPU utilization and power management by throttling back microprocessors not currently in use and speeding up needed CPU capacity, for example by reducing the clock speed of the CPU and other logic when the CPU is idle. This is accomplished in hardware, without adding to the software load of the processor.

The hardware based utilization counter and monitor avoids an additional set of software tasks to monitor CPU utilization, and reduces heat dissipation and battery drain. The microprocessor system has a CPU, a counter; and a clock. The clock provides a CLK signal to the counter when a software task is running on the CPU. The counter counts the number of clock pulses since a RESET, and the monitor performs a “sample and hold” on the counter, and provides a control output.

The CPU provides a RESET signal to the counter for each CLK pulse whenever a software task is not running on the CPU, that is, when the CPU is idle. Conversely, the CPU blocks a RESET signal to the counter whenever a software task is running on the CPU, and continuously passes CLK signals to the counter when a software task is running on the CPU.

The counter outputs a signal that is responsive to its content. This is sampled by the monitor which outputs a control signal. The control signal may be a power control signal, a function control signal, or even a clock control signal, responsive to monitor level. For example, the monitor may output a control signal reducing power input or clock pulse input to the CPU when monitor level is below a threshold.

A further aspect of our invention is a method of operating the microprocessor system where the clock provides a CLK signal train to the counter while a software task is running on the CPU, with the counter counting the number of clock pulses since a RESET, and the CPU providing a RESET signal to the counter for each CLK pulse when a software task is not running on the CPU.

### THE FIGURES

Various aspects of our invention are illustrated in the Figures appended hereto.

FIG. 1 shows a high level diagram of the system of the invention, including a CPU, a bridge, a counter, a utilization monitor, and a clock.

FIG. 2 illustrates a hypothetical operation of the microprocessor, including CLK pulses, the RESET pulses, a control threshold level, a counter value, and a monitor value.

### DETAILED DESCRIPTION OF THE INVENTION

The method and system of our invention provides a hardware based counter and monitor implemented solution for both throttling back microprocessors not currently in use, for example by reducing the clock speed of the CPU and other logic when the CPU is idle, and for increasing clock speed or bringing additional processors on line when additional processing capacity is needed. This is accomplished in hardware, without adding to the software load of the processor.

The hardware based utilization counter and monitor avoids an additional set or layer of software tasks to monitor CPU utilization, and employs a counter and monitor hardware solution to reduce heat dissipation and battery drain. The microprocessor system has a CPU, a counter; a monitor, and a clock. The clock provides a CLK signal to the counter when a software task is running on the CPU, and the counter counts the number of clock pulses since a RESET. The number of clock pulses since the last reset (that is, the value carried in the counter) is sampled by the monitor at the time of a reset. This sampled value is held by the monitor and is the output of the monitor.

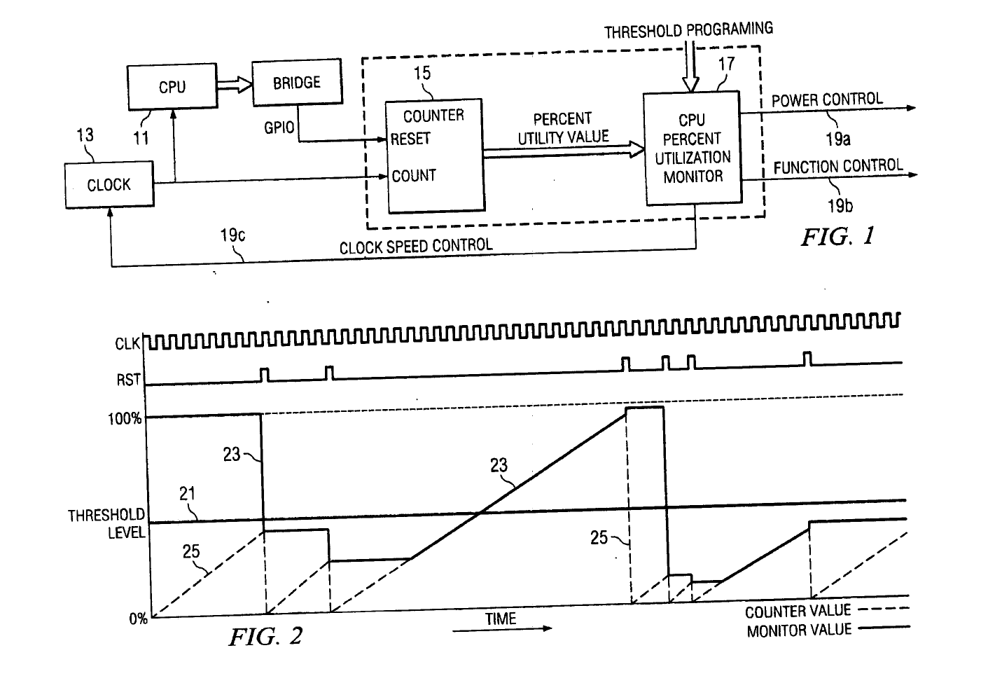

FIGS. 1 and 2 illustrate a preferred exemplification of our invention. FIG. 1, illustrates a hardware based utilization meter or monitor that avoids additional sets of software tasks to monitor CPU utilization, and to facilitate, for example, reduction of heat dissipation, control of battery drain, thermal management, or power management. The microprocessor system has a CPU, 11, a counter, 15; a monitor, 17, and a clock, 13. The clock, 13, provides a CLK signal to the counter, 15, and the counter, 15, counts the number of clock pulses since a RESET. A RESET resets the counter, 15, to zero, and sets the monitor, 17, to the level of the counter, 15, immediately prior to the RESET signal.

Central to the system is the counter, 15. As used herein a counter is a register that goes through a prescribed sequence of states upon the application of input pulses. In a generalized counter the input pulses may be clock pulses or pulses from some other external sources, and they may occur at fixed intervals or at random, and the sequence of states of the counter may follow a binary sequence of states or any other sequence of states. Counters are further characterized as “ripple counters” and “synchronous counters.” In a ripple counter the output of one flip-flop serves as the triggering input of a next flip flop. In a synchronous counter the “C” inputs of all of the flip flops receive a common input (typically a CLK signal) and the change of state is determined from the “present” state of the counter.

The CPU, 11, provides a RESET signal to the counter, 15, for each CLK pulse whenever a software task is not running on the CPU, 11, that is, when the CPU, 11, is idle. Conversely, the CPU, 11, blocks a RESET signal to the counter, 15, whenever a software task is running on the CPU, 11, and continuously passes CLK signals to the counter, 15, when a software task is running on the CPU, 11.

The counter, 15, outputs a signal to the monitor, 17, which samples and holds the counter output, and outputs one or more control signals, here illustrated as a power control, 19a, a function control, 19b, and a clock control, 19c, that are responsive to the monitor output.

For example, the monitor, 17, may output a control signal reducing power input or clock pulse input to the CPU, 11, responsive to monitor content as a measure of CPU utilization when the CPU utilization, modeled and represented by count content and monitor content, is below a threshold. Alternatively, clock speed may be increased or an additional CPU brought on line when the monitor content is above a threshold.

A further aspect of our invention is a method of operating the microprocessor system where the clock, 13, provides a CLK signal train to the counter, 15, while a software task is running on the CPU, 11. The counter, 15, counts the number of clock pulses since a RESET. The monitor, 17, performs a “sample and hold” on the output value of counter, 15, immediately prior to the last RESET, and the CPU, 11, provides a RESET signal to the counter, 15, for each CLK pulse when a software task is not running on the CPU, 11.

FIG. 2 illustrates on application of the system and method described herein. The dashed line, 25, represents the counter level, and the solid line, 23, represents a monitor level indicating percent CPU utilization. The heavy, horizontal, solid line, 21, represents a user or system set Threshold Level for taking some action, as reducing or increasing CLK speed, increasing or reducing power, or even starting up or shutting down a CPU.

At power up of the system (T₀), the CPU, 11, is assumed to run at 100% utilization until the first idle time. At this point the reset task is run and resets the counter, 15. The monitor output, 23, as an indicator of CPU utilization level, drops down to the count value, 25, on the counter, 15, at the time of the RESET, point 1. A short time later the CPU, 11, is idle again and the monitor, 17, drops the level, 23, to the value of the counter, 15, at the time of the RESET, point 2. The CPU, 11, remains active and the count level, 25, and the monitor level, 23, both exceed the threshold value, 21, at point 3.

The monitor level, 23, continues to increase according to the level, 25, of the counter, 15. At point 4 the CPU has another idle time, and the counter, 15, is reset. The monitor level, 23, holds the level at the time that the counter, 15, was reset, and the counter level, 23, drops. At point 5 the CPU, 11, encounters another idle time, and the counter 15, is again reset, with the counter level, 25, and the monitor level, 23, both dropping. Points 6 and 7 represent further idle times and RESET pulses.

The dotted line, 25, in FIG. 2, represents the instantaneous value of the counter, 15, and the solid line, 23, in FIG. 2, represents the value stored in the monitor, 17, which is the stored sample value of the counter, 15 (represented by 25) immediately prior to a RESET. This provides a “sample and hold” function, and prevents assertion of the controls, 19a, 19b, and 19c, at every reset, thereby providing a smooth control function.

Of particular note is the “Threshold Level” line, 21. This can be used as a set point for various actions, for example reducing clock speed or power when percent CPU utilization drops below the threshold, or starting up another CPU when percent utilization exceeds the threshold (or another, separately set threshold).

The Threshold Level (or levels) provide one or more control points. With a single Threshold Line, as shown in FIG. 2, control will be in one state when percent utilization is above the Threshold Level, and in another state when the percent utilization is below the Threshold Level.

The method and system described herein allow the control of system functions based upon CPU, 11, utilization with very little support from software or microcode. The reaction time to changes in CPU utilization is faster then would be the case with software based or microcode based control. By way of contrast, in the case of software based or microcode based control, it would take longer to speed up the clock, 15, as the clock, 15, would still be operating at a lower speed. Moreover, the monitoring software would be competing for clock cycles with other software processes operating on the CPU, further slowing down the response time.

While the invention has been described with respect to certain preferred exemplifications and embodiments, it is not intended to limit the scope of the invention thereby, but solely by the claims appended hereto.

1. A microprocessor system comprising a CPU, a clock providing a CLK signal to the CPU, a counter counting clock pulses to the CPU, and a monitor, wherein the clock is adapted to provide a CLK signal to the counter when a software task is running on the CPU, said counter adapted to count the number of clock pulses since a RESET; the CPU is adapted to provide a RESET signal to the counter for each CLK pulse when a software task is not running on the CPU; and the monitor is adapted to store the value in the counter immediately prior to the last RESET.

2. The microprocessor system of claim 1 wherein the CPU is adapted to block a RESET signal to the counter when a software task is running on the CPU.

3. The microprocessor system of claim 1 wherein the CPU is adapted to continuously pass CLK signals to the counter when a software task is running on the CPU.

4. The microprocessor system of claim 1 wherein the CPU is adapted to pass a RESET signal to the counter when is software task is not running on the CPU.

5. The microprocessor system of claim 1 wherein the monitor is adapted to output a control signal responsive to monitor content.

6. The microprocessor system of claim 5 wherein the monitor is adapted to output a power control signal responsive to monitor content.

7. The microprocessor system of claim 5 wherein the monitor is adapted to output a function control signal responsive to monitor content.

8. The microprocessor system of claim 5 wherein the monitor is adapted to output a clock control signal responsive to monitor content.

9. The microprocessor system of claim 5 wherein the monitor is adapted to output a control signal reducing power input to the CPU responsive to monitor content when the monitor content is below a threshold.

10. The microprocessor system of claim 5 wherein the monitor is adapted to output a control signal reducing clock pulse input to the CPU responsive to count content when the monitor content is below a threshold.

11. A method of operating a microprocessor system, said system comprising a CPU, a counter, a monitor, and a clock, and wherein the clock provides a CLK signal train to the counter while a software task is running on the CPU, the counter counting the number of clock pulses since a RESET, the CPU providing a RESET signal to the counter for each CLK pulse when a software task is not running on the CPU, and the monitor storing the value of the counter prior to the last RESET.

12. The method of claim 11 wherein the CPU blocks the RESET signal to the counter when a software task is running on the CPU.

13. The method of claim 11 wherein the CPU continuously passes CLK signals to the counter when a software task is running on the CPU.

14. The method of claim 11 wherein the CPU passes a RESET signal to the counter when is software task is not running on the CPU.

15. The method of claim 1 1 wherein the monitor outputs a control signal responsive to count content.

16. The method of claim 15 wherein the monitor outputs a power control signal responsive to monitor content.

17. The method of claim 15 wherein the monitor outputs a function control signal responsive to monitor content.

18. The method of claim 15 wherein the monitor outputs a clock control signal responsive to monitor content.

19. The method of claim 15 wherein the monitor outputs a control signal reducing power input to the CPU responsive to monitor content when the monitor content is below a threshold.

20. The method of claim 15 wherein the monitor outputs a control signal reducing clock speed of the CPU responsive to monitor content when the monitor content is below a threshold.
